(19) United States
(12) Patent Application Publication
(10) Pub. No.: US 2007/0097035 A1
(43) Pub. Date: May 3, 2007

(54) Plasma display apparatus

(75) Inventors: Byung Nam Ahn, Seoul (KR); Hai Young Jung, Incheon (KR)

Correspondence Address: KED & ASSOCIATES, LLP, P.O. Box 221200, Chantilly, VA, 20153-1200, US

(73) Assignee: LG Electronics Inc.

(21) Appl. No.: 11/588,231

(22) Filed: Oct. 27, 2006

(30) Foreign Application Priority Data
Oct. 28, 2005 (KR) 10-2005-0102622
Oct. 28, 2005 (KR) 10-2005-0102623
Oct. 28, 2005 (KR) 10-2005-0102624

(51) Int. Cl. G09G 3/28

(52) U.S. Cl. 345/68

(57) ABSTRACT

A plasma display apparatus is disclosed The plasma display apparatus includes a first voltage source, a multiplying unit, and a sustain pulse supply controller. The multiplying unit is charged to a voltage of the first voltage source, and then supplies a multiplying voltage equal to two times the voltage of the first voltage source to a panel capacitor. The sustain pulse supply controller is connected between the multiplying unit and the panel capacitor, and controls the supplying of the multiplying voltage supplied by the multiplying unit to the panel capacitor.

This Nonprovisional application claims priority under 35 U.S.C. § 119(a) on Patent Application Nos. 10-2005-0102622, 10-2005-0102623 and 10-2005-0102624 filed in Korea on Oct. 28, 2005 the entire contents ofwhich are hereby incorporated by reference.

### BACKGROUND

1. Field

This document relates to a display apparatus, and more particularly, to a plasma display apparatus.

2. Description of the Related Art

Out of display apparatuses, a plasma display apparatus comprises a plasma display panel and a driver for driving the plasma display paneL

There is a problem in that a cathode ray tube is heavy and bulky. Accordingly, various flat display apparatuses for solving the problem of the cathode ray tube have been developed Examples of the flat display apparatuses include a liquid crystal display (LCD), a field emission display (FED), a plasma display panel (PDP), and an electro-luminescence (EL) display.

The PDP uses a gas discharge, and has an advantage in easily manufacturing a large-sized paneL Recently, most of the PDPs have a three-electrode surface-discharge type structure in which a scan electrode and a sustain electrode are formed on a front substrate and an address electrode is formed on a rear substrate.

The three-electrode surfacedischarge type PDP is driven by dividing a frame into several subfields. The number of light-emission times, which is proportionate to weight values of video data, is generated in each of the subfields such that gray level of an image is represented. Each of the subfields is subdivided into a reset period, an address period and a sustain period

In the reset period, wall charges are uniformly formed within a discharge cell. In the address period, a selective address discharge depending on a logical value of the video data occurs. In the sustain period, a discharge is maintained within a discharge cell selected by performing the address discharge.

In the three-electrode surface-discharge type PDP thus driven, a high voltage of several hundreds of volt is required to perform the address discharge and the sustain discharge. Accordingly, an energy recovery apparatus is used in the three-electrode surface-discharge type PDP to lower a driving voltage required in performing address discharge and the sustain discharge.

### SUMMARY

In one aspect a plasma display apparatus cornprises a first voltage source, a multiplying unit which is charged to a voltage of the first voltage source, and then supplies a multiplying voltage equal to two times the voltage of the first voltage source to a panel capacitor, and a sustain pulse supply controller, connected between the multiplying unit and the panel capacitor, for controlling the supplying of the multiplying voltage supplied by the multiplying unit to the panel capacitor.

In another aspect a plasma display apparatus comprises a first voltage source, a first multiplying unit charged to a voltage of the first voltage source, a second multiplying unit which is charged to a sum of the voltage of the first voltage source and a charging voltage to the first multiplying unit, and then supplies a multiplying voltage equal to three times the voltage of the first voltage source to a panel capacitor, and a sustain pulse supply controller, connected between the second multiplying unit and the panel capacitor, for controlling the supplying of the multiplying voltage supplied by the second multiplying unit to the panel capacitor.

In still another aspect a plasma display apparatus comprises a first voltage source and a second voltage source, a first multiplying unit charged to a voltage of the first voltage source and a voltage of the second voltage source, a second multiplying unit which is charged to the voltage of the first voltage source and a charging voltage to the first multiplying unit, and then supplies a multiplying voltage equal to four times the voltage of the first voltage source to a panel capacitor, and a sustain pulse supply controller, connected betweenthe second multiplying unit and the panel capacitor, for controlling the supplying of the multiplying voltage supplied by the second multiplying unit to the panel capacitor.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates a driving waveforn of a plasma display apparatus according to embodiments;

FIG. 2 is a circuit diagram of a plasma display apparatus according to a first embodiment;

FIG. 3 is a timing chart illustrating on/off time of switches of FIG. 2;

FIGS. 4 and 5 are a circuit diagram of a current path formed in accordance with the on/off timing of the switches illustrated in FIG. 3;

FIG. 6 is a circuit diagram of a plasma display apparatus according to a second embodiment;

FIGS. 7 to 10 are a circuit diagram of a current path formed in accordance with on/off timing of switches of the plasma display apparatus of FIG. 6;

FIG. 11 is a circuit diagram of a plasma display apparatus according to a third embodiment;

FIG. 12 is a timing chart illustrating on/off time of switches of FIG. 11;

FIGS. 13 and 14 are a circuit diagram of a current path formed in accordance with the on/offtiming ofthe switches illustrated in FIG. 12;

FIG. 15 is a circuit diagram of a plasma display apparatus according to a fourth embodiment;

FIGS. 16 to 19 are a circuit diagram of a current path formed in accordance with on/off timing of switches of the plasma display apparatus of FIG. 15;

FIG. 20 is a circuit diagram of a plasma display apparatus according to a fifth embodiment;

FIG. 21 is a timing chart illustrating on/off time of switches of FIG. 20;

FIGS. 22 and 23 are a circuit diagram of a current path formed in accordance with the on/off timing of the switches illustrated in FIG. 21;

FIG. 24 is a circuit diagram of a plasma display apparatus according to a sixth embodiment; and

FIGS. 25 to 28 are a circuit diagram of a current path formed in accordance with on/off timing of switches of the plasma display apparatus of FIG. 24.

### DETAILED DESCRIPTION OF PREFERRED EMBODIMENTS

Reference will now be made in detail embodiments of the invertion examples of which are illustrated in the accompanying drawings.

A plasma display apparatus comprises a first voltage source, a multiplying unit which is charged to a voltage of the first voltage source, and then supplies a multiplying voltage equal to two times the voltage of the first voltage source to a panel capacitor, and a sustain pulse supply controller, connected between the multiplying unit and the panel capacitor, for controlling the supplying of the multiplying voltage supplied by the multiplying unit to the panel capacitor.

A magnitude of the multiplying voltage may be equal to a sustain voltage.

A magnitude of the voltage of the first voltage source may be equal to one half the sustain voltage.

The multiplying unit may comprise a multiplying capacitor charged to the voltage of the first voltage source, for supplying the multiplying voltage to the panel capacitor, and a third switch turned on to raise a voltage of the multiplying capacitor to the multiplying voltage.

The sustain pulse supply controller may comprise a first switch which is connected between the multiplying unit and the panel capacitor, and is turned on to supply the multiplying voltage to the panel capacitor, and a second switch which is connected between the panel capacitor and a ground level voltage source, and is turned on to supply a ground level voltage to the panel capacitor and to charge the multiplying capacitor of the multiplying unit to the voltage of the first voltage source.

A current path for charging the multiplying capacitor to the voltage of the first voltage source may be formed to pass through the first voltage source, the multiplying capacitor and the second switch.

A current path for supplying the sustain voltage to the panel capacitor may be formed to pass through the first voltage source, the third switch, the multiplying capacitor and the first switch.

The plasma display apparatus may further comprise an energy recovery/supply unit for recovering energy from the panel capacitor and for supplying the recovered energy to the panel capacitor.

A plasma display apparatus comprises a first voltage source, a first multiplying unit charged to a voltage of the first voltage source, a second multiplying unit which is charged to a sum of the voltage of the first voltage source and a charging voltage to the first multiplying unit, and then supplies a multiplying voltage equal to three times the voltage of the first voltage source to a panel capacitor, and a sustain pulse supply controller, connected between the second multiplying unit and the panel capacitor, for controlling the supplying of the multiplying voltage supplied by the second multiplying unit to the panel capacitor.

A magnitude of the multiplying voltage may be equal to a sustain voltage.

A magnitude of the voltage of the first voltage source may be equal to one-third of the sustain voltage.

The first multiplying unit may comprise a second capacitor, charged to the voltage of the first voltage source, for supplying the charging voltage to the second multiplying unit, a fifth switch turned on to supply the charging voltage to the second multiplying unit, and a fourth switch connected in parallel to the second capacitor.

The second multiplying unit may comprise a first capacitor which is charged to the voltage of the first voltage source and a charging voltage to the first multiplying unit, and supplies the multiplying voltage to the panel capacitor, and a third switch which is turned on to raise the voltage of the first capacitor to the multiplying voltage while charging the second capacitor to the voltage of the first voltage source.

The sustain pulse supply controller may comprise a first switch which is connected between the second multiplying unit and the panel capacitor, and is turned on to supply the multiplying voltage to the panel capacitor, and a second switch which is connected between the panel capacitor and a ground level voltage source, and is turned on to supply a ground level voltage to the panel capacitor.

A current path for charging the second capacitor to the voltage of the first voltage source may be formed to pass through the first voltage source, the third switch, the second capacitor and the ground level voltage source. A current path for charging the first capacitor to the voltage of the first voltage source and a charging voltage to the second capacitor may be formed to pass through the first voltage source, the first capacitor, the fifth switch, the second capacitor, the fourth switch and the ground level voltage source.

A current path for supplying the sustain voltage to the panel capacitor may be formed to pass through the first voltage source, the third switch, the first capacitor and the first switch

The plasma display apparatus may further comprise an energy recovery/supply unit for recovering energy from the panel capacitor and for supplying the recovered energy to the panel capacitor.

A data pulse may be supplied to an address electrode using the first voltage source during an address period.

A plasma display apparatus comprises a first voltage source and a second voltage source, a first multiplying unit charged to a voltage of the first voltage source and a voltage of the second voltage source, a second multiplying unit which is charged to the voltage of the first voltage source and a charging voltage to the first multiplying unit, and then supplies a multiplying voltage equal to four times the voltage of the first voltage source to a panel capacitor, and a sustain pulse supply controller, connected between the second multiplying unit and the panel capacitor, for controlling the supplying of the multiplying voltage supplied by the second multiplying unit to the panel capacitor.

A magnitude of the multiplying voltage may be equal to a sustain voltage.

A magnitude of the voltage of the first voltage source may be equal to one quarter of the sustain voltage, and a magnitude of the voltage of the second voltage source may be equal to one quarter of the sustain voltage.

The first multiplying unit may comprise a second capacitor which is charged to the voltage of the first voltage source and the voltage of the second voltage source, and supplies the charging voltage to the second multiplying unit, a fourth switch which is turned on to supply the charging voltage to the first multiplying unit to the second multiplying unit, and a fifth switch connected in parallel to the second capacitor.

The second multiplying unit may comprise a first capacitor which is which is charged to the voltage of the first voltage source and a charging voltage to the first multiplying unit, and supplies the multiplying voltage to the panel capacitor, and a third switch which is turned on to raise the voltage of the first capacitor to the multiplying voltage while charging the second capacitor to the voltage of the first voltage source.

The sustain pulse supply controller may comprise a first switch which is connected between the second multiplying unit and the panel capacitor, and is turned on to supply the multiplying voltage to the panel capacitor, and a second switch which is connected between the panel capacitor and a ground level voltage source, and is turned on to supply a ground level voltage to the panel capacitor.

A current path for charging the second capacitor to the voltage of the first voltage source may be formed to pass through the first voltage source, the third switch, the second capacitor, and the ground level voltage source. A current path for charging the second capacitor to the voltage of the second voltage source and a current path for charging the first capacitor to the voltage of the first voltage source and the charging voltage to the second capacitor may be formed to pass through the first voltage source, the first capacitor, the fourth switch, the seccnd capacitor, the fifth switch and the second voltage source.

A current path for supplying the sustain voltage to the panel capacitor may be formed to pass through the first voltage source, the third switch, the first capacitor and the first switch

The plasma display apparatus may further comprise an energy recovery/supply unit for recovering energy from the panel capacitor and for supplying the recovered energy to the panel capacitor.

A data pulse may be supplied to an address electrode using the first voltage source during an address period.

A scan pulse of a negative polarity may be supplied to a scan electrode using the seccnd voltage source during an address period.

Hereinafter, exemplary embodiments of the present invention will be described in detail with reference to the attached drawings.

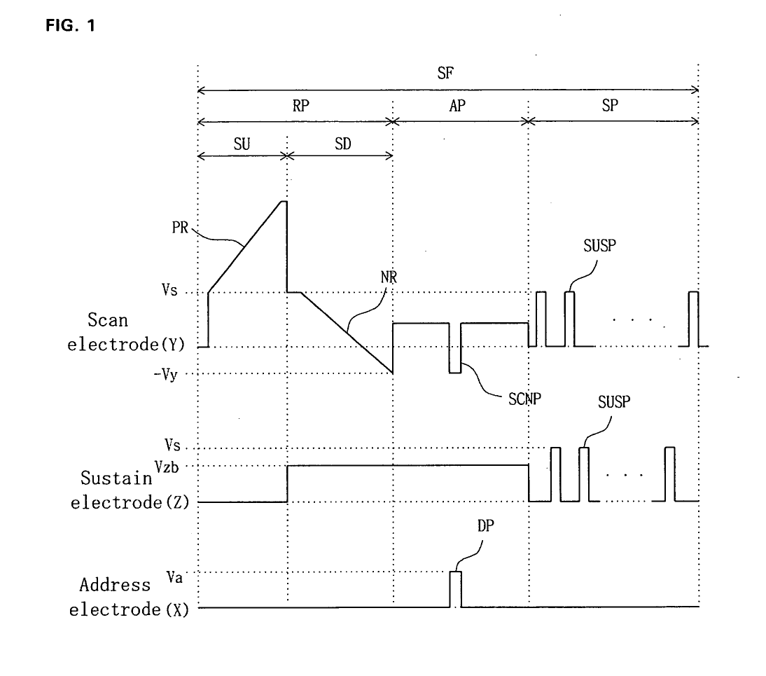

FIG. 1 illustrates a driving waveform of a plasma display apparatus according to embodiments.

As illustrated in FIG. 1, each of subfields SF is divided into a reset period RP for initializing all discharge cells of the whole screen, an address period AP for selecting a discharge cell to be discharged, and a sustain period SP for discharge maintenance of the selected discharge cell.

The reset period RP is further divided into a setup period SU and a set-down period SD. During the setup period SU, a gradually rising pulse PR is simultaneously supplied to all scan electrodes Y. The gradually rising pulse PR generates a weak dark discharge (i.e., a setup discharge) within the discharge cells of the whole screen such that wall charges are formed within the discharge cells.

During the set-down period SD, a falling pulse NR, which gradually falls from a positive sustain voltage Vs lower than a peak voltage of the gradually rising pulse PR to a negative scan voltage —Vy with a predetermined slope, is simultaneously supplied to the scan electrodes Y.

The falling pulse NR generates a weakerase discharge within the discharge cells, thereby erasing unnecesary charges in the wall charges and space charges produced by performing the setup discharge. The remaining wall charges are uniform inside the discharge cells to the extent that an address discharge can be stably performed.

During the address period AP, a scan pulse SCNP of a negative polarity is sequentially applied to the scan electrodes Y and, at the same time, a data pulse DP of a positive polarity is applied to address electrodes X.

As the voltage difference between the scan pulse SCNP and the data pulse DP is added to the wall voltage generated during the reset period RP, the address discharge is generated within the discharge cell to which the data pulse DP is supplied. Wall charges are formed inside the cells selected by performing the address discharge.

A positive bias voltage Vzb is supplied to sustain electrodes Z during the set-down period SD and the address period AP.

During the sustain period SP, a sustain pulse SUSP is alternately supplied to the scan electrodes Y and the sustain electrodes Z. As the wall voltage within the cells selected by performing the address discharge is added to the sustain pulse SUSP, every time the sustain pulse SUSP is applied, a sustain discharge, i.e., a display discharge occus between the scan electrodes Y and the sustain electrodes Z in a surface discharge form.

The driving of the plasma display apparatus is completed in one subfield through the above-described driving processes.

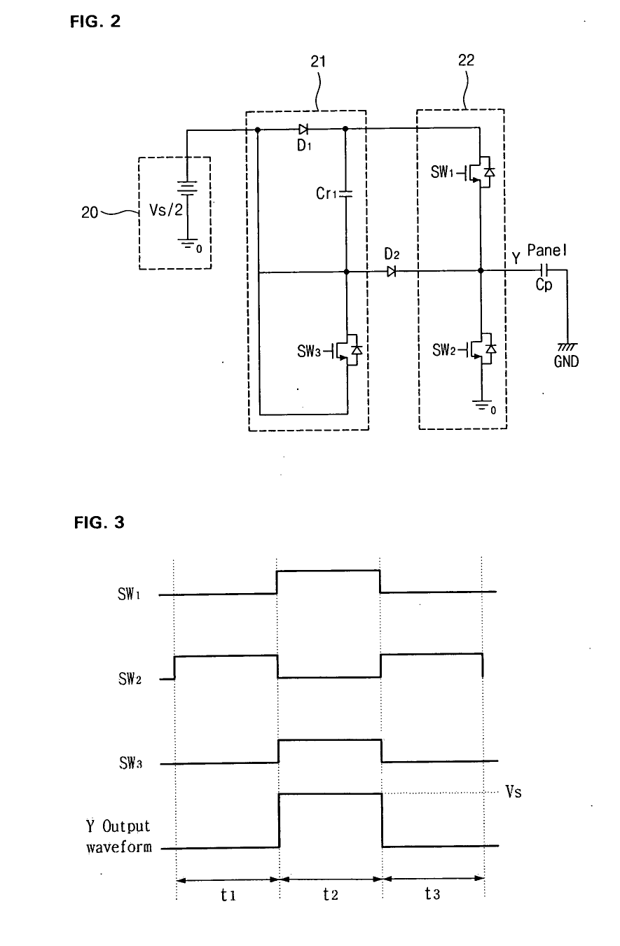

FIG. 2 is a circuit diagram of a plasma display apparatus according to a first embodiment.

As illustrated in FIG. 2, the plasma display apparatus according to the first embodiment comprises a first voltage source 20, a multiplying unit 21 and a sustain pulse supply controller 22.

The first voltage source 20 is connected to one terminal of the multiplying unit 21 such that a multiplying capacitor Cr1 of the multiplying unit 21 is charged to a voltage of the first voltage source 20. The multiplying unit 21 raises a voltage of the multiplying capacitor Cr1 to a multiplying voltage Vs so that a voltage finally supplied to a panel capacitor Cp is equal to a sustain voltage Vs.

The voltage of the first voltage source 20 maybe equal to one half the multiplying voltage Vs to be supplied to the panel capacitor Cp.

The panel capacitor Cp equivalently indicates capacitance formed between the scan electrode Y and the sustain electrode Z of the plasma display panel.

The circuit having the configuration illustrated in FIG. 2 is symmetrically installed in each of the scan electrode Y and the sustain electrode Z with the panel capacitor Cp being interposed betweenthe scan electrode Y and the sustain electrode Z. In FIG. 2, the circuit installed in the scan electrode Y is illustrated.

The multiplying unit 21 is connected between the first voltage source 20 and the sustain pulse supply controller 22. The multiplying unit 21 is charged to a voltage Vs/2 of the first voltage source 20, and then supplies the multiplying voltage Vs equal to two times the voltage Vs/2 of the first voltage source 20 to the panel capacitor Cp.

The multiplying voltage is equal to the sustain voltage Vs finally supplied to the panel capacitor Cp.

The multiplying capacitor Cr1 is connected between a common terminal of a third switch SW3 and a second diode D2 and a common tenninal of a first switch SW1 and a first diode D1. The multiplying capacitor Cr1 is charged to the voltage Vs/2 of the first voltage source 20 and supplies the multiplying voltage Vs to the panel capacitor Cp.

The third switch SW3 is connected between a common terminal of the multiplying capacitor Cr1 and the second diode D2 and the first voltage source 20. The third switch SW3 is turned on so that a voltage of the multiplying capacitor Cr1 rises to the multiplying voltage Vs being the sustain voltage to be finally supplied to the panel capacitor Cp.

The first diode D1 is connected between a common terminal of the multiplying capacitor Cr1 and the first switch SW1 and the first voltage source 20, thereby preventing an inverse current.

The sustain pulse supply controller 22 is connected between the multiplying unit 21 and the panel capacitor Cp to control the supplying of the multiplying voltage Vs supplied by the multiplying unit 21 to the panel capacitor Cp.

The first switch SW1 is connected between a common terminal of the first diode D1 and the multiplying capacitor Cr1 and the panel capacitor Cp. The first switch SW1 is turned on so that the multiplying voltage Vs is supplied to the panel capacitor Cp.

A second switch SW2 is connected between the panel capacitor Cp and a ground level voltage source (not illustrated). The second switch SW2 is turned on so that a ground level voltage GND is supplied to the panel capacitor Cp and the multiplying capacitor Cr1 of the multiplying unit 21 is charged to the voltage Vs/2 ofthe first voltage source 20.

The second diode D2 is connected between a common terminal of the multiplying capacitor Cr1 and the third switch SW3 and the panel capacitor Cp, thereby preventing an inverse current.

The first to third switches SW1 to SW3 control the flowing of a current through their turn-on and turn-off operations. The first to third switches SW1 to SW3 function as a semiconductor switch element such as a metal oxide silicone field effect transistor (MOSFET), an insulated gate bipolar transistor (IGBT), a silicon controlled rectifier (SCR), a bipolarjunction transistors (BJT). Further, the first diode D1 and the second diode D2 may be removed.

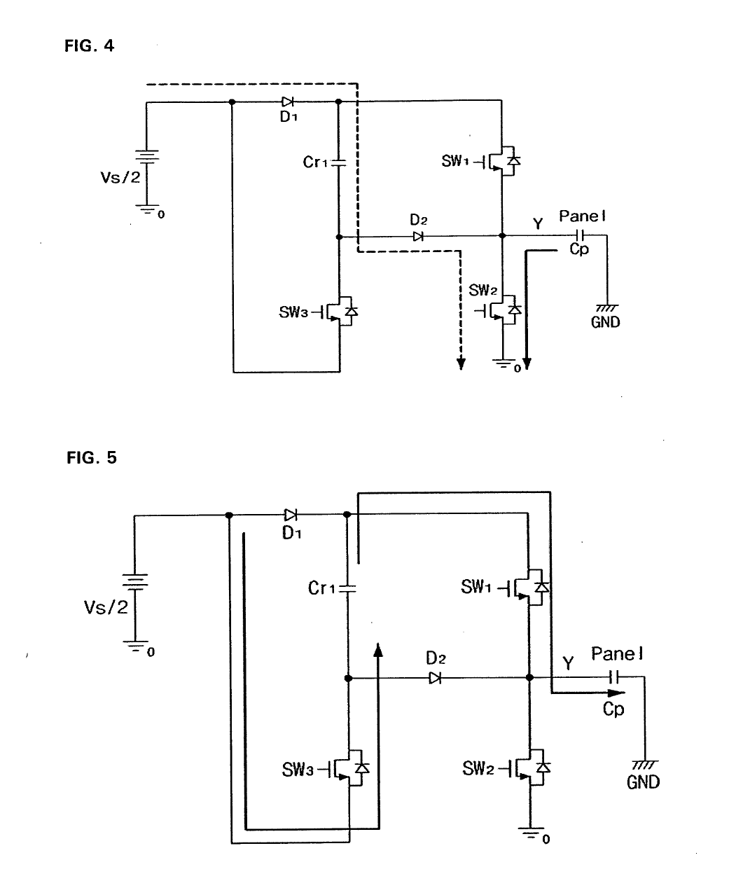

FIG. 3 is a timing chart illustrating on/off time of switches of FIG. 2. FIGS. 4 and 5 are a circuit diagram of a current path formed in accordance with the on/off timing of the switches illustrated in FIG. 3.

Referring to FIGS. 3 to 5, during a period t1, the second switch SW2 is turned on in response to a second switching control signal in a high state supplied by a timing controller (not illustrated).

As a result, as illustrated in FIG. 4, a current path (indicated by a bold solid line) passing through the panel capacitor Cp, the second switch SW2 and the ground level voltage source is formed such that a voltage of the panel capacitor Cp is maintained at the ground level voltage GND during the period t1.

Further, a current path (indicated by a dotted line) passing through the first voltage source 20, the first diode D1, the multiplying capacitor Cr1, the second diode D2, the second switch SW2 and the ground level voltage source is formed such that the multiplying capacitor Cr1 is charged to the voltage Vs/2 of the first voltage source 20 during the period t1.

During a period t2, the first switch SW1 and the third switch SW3 are turned on in response to first and third switching control signals in a high state supplied by the timing controller, and the second switch SW2 is turned off in response to a second switching control signal in a low state.

As a result, as illustrated in FIG. 5, a current path passing through the first voltage source 20, the third switch SW3, the multiplying capacitor Cr1, the first switch SW1 and the panel capacitor Cp is formed. A sum (i.e., the multiplying voltage Vs) of a charging voltage Vs/2 to the multiplying capacitor Cr1 during the period t1 and a voltage Vs/2 of the multiplying capacitor Cr1 supplied by the first voltage source 20 through the current path formed during the period t2is supplied to the panel capacitor Cp.

Accordingly, a voltage of the panel capacitor Cp is maintained at the sustain voltage Vs during the period t2.

As described above, a voltage of a sustain voltage source is not directly supplied to the panel capacitor Cp, and a voltage Vs equal to two times the voltage Vs/2 of the first voltage source 20 is supplied to the panel capacitor Cp through the multiplying capacitor Cr1 of the multiplying unit 21. Accordingly, voltage stress applied to the components (for example, the first and third switches SW1 and SW3) in the circuit of the plasma display apparatus is reduced to a voltage of Vs/2 equal to one half the sustain voltage Vs, thereby using the switches with low capacitance.

Afterwards, a sustain pulse is supplied to the panel capacitor Cp by repeating the operations performed during the periods t1 and t2.

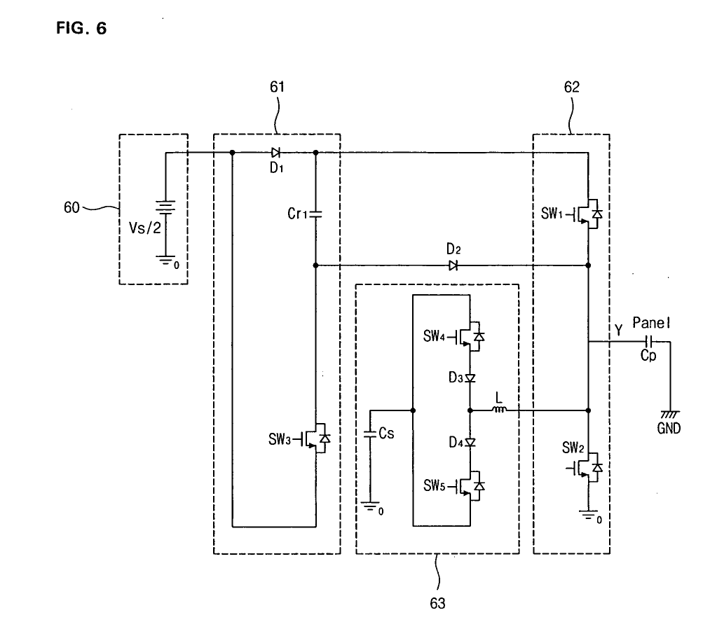

The following is a detailed description of a plasma display apparatus according to a second embodiment, with reference to FIGs. 6 to 10.

FIG. 6 is a circuit diagram of a plasma display apparatus according to a second embodiment.

As illustrated in FIG. 6, the plasma display apparatus according to the second embodiment comprises a first voltage source 60, a multiplying unit 61, a sustain pulse supply controller 62 and an energy recovery/supply unit 63.

Since the configuration of the plasma display apparatus according to the second embodiment is the same as the configuration of the plasma display apparatus according to the first embodiment except the energy recovery/supply unit 63, a description thereof is omitted.

The energy recovery/supply unit 63 comprises a source capacitor Cs, an inductor L, a fourth switch SW4, a fifth switch SW5, a third diode D3 and a fourth diode D4. The energy recovery/supply unit 63 is connected to a commmon terminal of a panel capacitor Cp, a first switch SW1 and a second switch SW2. The energy recovery/supply unit 63 recovers energy from the panel capacitor Cp and supplies the recovered energy to the panel capacitor Cp.

The source capacitor Cs is connected to a common terminal of the fourth switch SW4 and the fifth switch SW5. The source capacitor Cs recovers a charging voltage to the panel capacitor Cp when generating a sustain discharge, and is then charged to the charging voltage. The source capacitor Cs supplies the voltage charged inside the source capacitor Cs to the panel capacitor Cp.

The inductor L is connected between the source capacitor Cs and the sustain pulse supply controller 62, and has constant inductance. The inductor L and the panel capacitor Cp form a resonance circuit.

The fourth switch SW4 and the fifth switch SW5 are connected between the source capacitor Cs and the inductor L in paralleL The fourth switch SW4 is turned on when the source capacitor Cs recovers the charging voltage to the panel capacitor Cp, and the fifth switch SW5 is turned on when supplying again the voltage charged inside the source capacitor Cs to the panel capacitor Cp.

The third diode D3 is connected betweenthe fourth switch SW4 and the inductor L, and the fourth diode D4 is connected between the fifth switch SW5 and the inductor L, thereby preventing an inverse current.

The first to fifth switches SW1 to SW5 control the flowing of a current through their turn-on and turn-off operations. The first to fifth switches SW1 to SW5 function as a semiconductor switch element such as MOSFET, IGBT, SCR, BJT. Further, a first diode D1, a second diode D2, the third diode D3 and the fourth diode D4 may be removed.

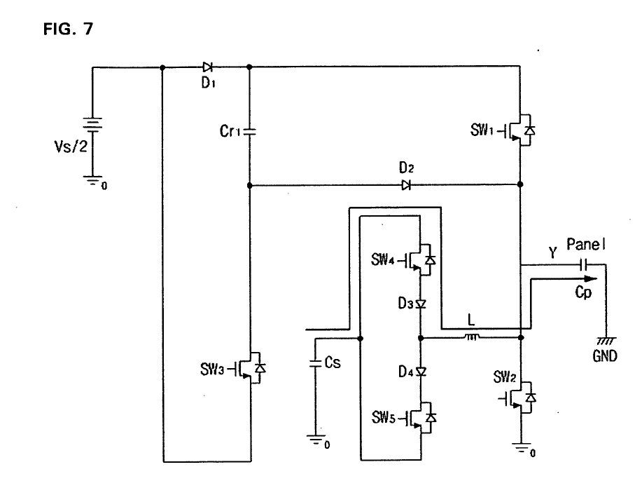

FIGS. 7 to 10 are a circuit diagram of a current path formed in accordance with on/off timing of switches of the plasma display apparatus of FIG. 6.

Suppose that the charging voltage to the panel capacitor Cp is equal to 0 V, and the charging voltage to the source capacitor Cs is equal to one half the sustain voltage Vs.

Referring to FIG. 7, the fourth switch SW4 is turned on in response to a fourth switching control signal in a high state supplied by a timing controller (not illustrated).

As a result, as illustrated in FIG. 7, a current path passing through the source capacitor Cs, the fourth switch SW4, the third diode D3, the inductor L and the panel capacitor Cp is formed such that the inductor L and the panel capacitor Cp form serial resonance.

Accordingly, a voltage of the panel capacitor Cp rises from a ground level voltage GND to the sustain voltage Vs.

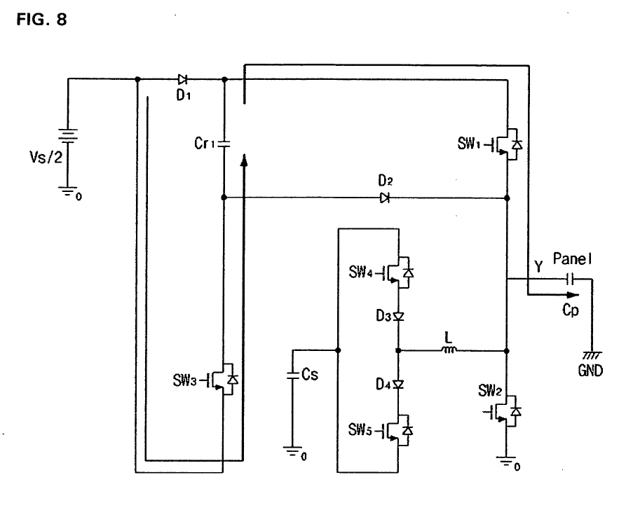

Refering to FIG. 8, the first switch SW1 and the third switch SW3 are turned on in response to first and third switching control signals in a high state supplied by the timing controller.

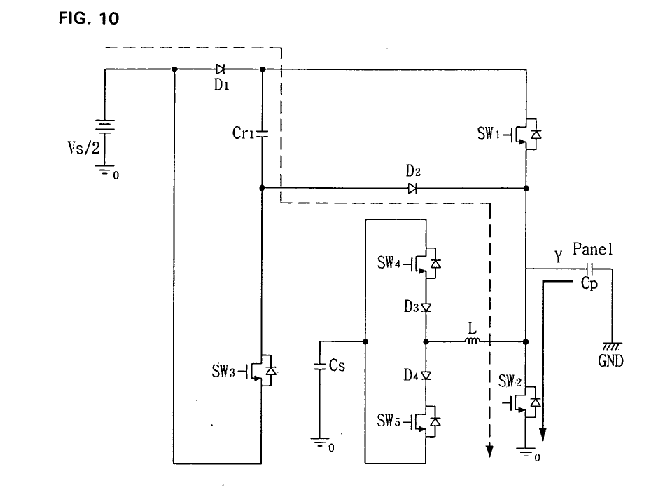

As a result, as illustrated in FIG. 8, a current path passing through the first voltage source 60, the third switch SW3, a multiplying capacitor Cr1, the first switch SW1 and the panel capacitor Cp is formed A sum (i.e., a multiplying voltage Vs) of a charging voltage Vs/2 to the multiplying capacitor Cr1 during the operation of the circuit illustrated in FIG. 10, which will be described later, and a voltage Vs/2 of the multiplying capacitor Cr1 supplied by the first voltage source 60 through the current path illustrated in FIG. 8 is supplied to the panel capacitor Cp. Accordingly, a voltage of the panel capacitor Cp is maintained at the sustain voltage Vs.

As described above, a voltage of a sustain voltage source is not directly supplied to the panel capacitor Cp and a voltage Vs equal to two times the voltage Vs/2 of the first voltage source 60 is supplied to the panel capacitor Cp through the multiplying capacitor Cr1 of the multiplying unit 61. Accordingly, voltage stress applied to the components (for example, the first and third switches SW1 and SW3) in the circuit of the plasma display apparatus is reduced to a voltage of Vs/2 equal to one half the sustain voltage Vs, thereby using the switches with low capacitance.

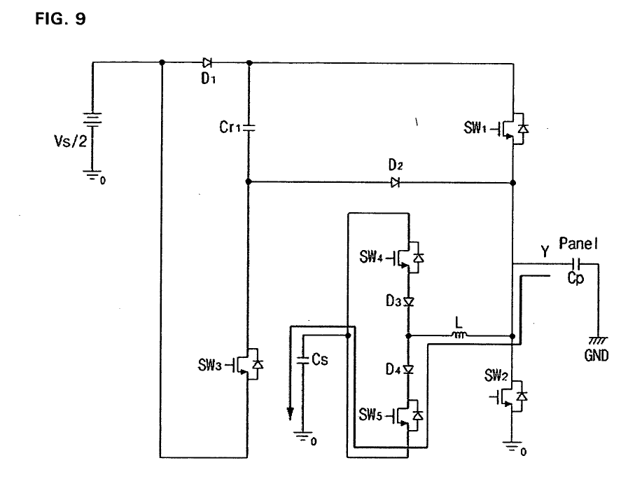

Referring to FIG. 9, the fifth switch SW5 is turned on in response to a fifth switching control signal in a high state supplied by the timing controller.

As a result, as illustrated in FIG. 9, a current path passing through the panel capacitor Cp, the inductor L, the fourth diode D4, the fifth switch SW5 and the source capacitor Cs is formed such that the inductor L and the panel capacitor Cp form serial resonance. Accordingly, a voltage of the panel capacitor Cp falls from the sustain voltage Vs to the ground level voltage GND.

Referring to FIG. 10, the second switch SW2 is turned on in response to a second switching control signal in a high state supplied by the timing controller.

As a result, as illustrated in FIG. 10, a current path passing (indicated by a bold solid line) through the panel capacitor Cp, the second switch SW2 and a ground level voltage source (not illustrated) is formed such that a voltage of the panel capacitor Cp is maintained at the ground level voltage GND.

Further, a current path (indicated by a dotted line) passing through the first voltage source 60, the first diode D1, the multiplying capacitor Cr1, the second diode D2, the seccnd switch SW2 and the ground level voltage source is formed such that the multiplying capacitor Cr1 is charged to the voltage Vs/2 of the first voltage source 60.

Afterwards, a sustain pulse is supplied to the panel capacitor Cp by repeating the operations illustrated in FIGS. 7 to 10.

FIG. 11 is a circuit diagram of a plasma display apparatus according to a third embodiment.

As illustrated in FIG. 11, the plasma display apparatus according to the third embodiment comprises a first voltage source 110, a first multiplying unit 112, a second multiplying unit 111 and a sustain pulse supply controller 113.

The first voltage source 110 is connected to one terminal of the second multiplying unit 111 such that a first capacitor Cr1 of the second multiplying unit 111 is charged to a voltage of the first voltage source 110, and a second capacitor Cr2 ofthe first multiplying unit 112 is charged to a voltage of the first voltage source 10. The second multiplying unit 111 raises a charging voltage to the first capacitor Cr1 to a multiplying voltage Vs so that a voltage finally supplied to a panel capacitor Cp is equal to a sustain voltage Vs.

The voltage of the first voltage source 110 may be equal to one-third of the multiplying voltage Vs to be supplied to the panel capacitor Cp.

The panel capacitor Cp equivalently indicates capacitance formed between a scan electrode Y and a sustain electrode Z of the plasma display panel.

The circuit having the configuration illustrated in FIG. 11 is symmetrically installed in each of the scan electrode Y and the sustain electrode Z with the panel capacitor Cp being interposed between the scan electrode Y and the sustain electrode Z. In FIG. 11, the circuit installed in the scanelectrode Y is illustrated.

The first multiplying unit 112 is charged to the voltage Vs/3 ofthe first voltage source 110, and then supplies the charging voltage Vs/3 to the second multiplying unit 111.

The second capacitor Cr2 is connected between a common terminal of a third diode D3 and a fourth switch SW4 and a common terminal of a second diode D2 and a fifth switch SW5. The second capacitor Cr2 is charged to the voltage Vs/3 of the first voltage source 110, and then supplies the charging voltage Vs/3 to the second multiplying unit 111.

The fifth switch SW5 is connected between a common terminal of the first capacitor Cr1 and a third switch SW3 and a common terminal of the second capacitor Cr2 and the second diode D2. The fifth switch SW5 is turned on so that the charging voltage Vs/3 to the second capacitor Cr2 is supplied to the second multiplying unit 111.

The fourth switch SW4 is connected in parallel to the second capacitor Cr2. The fourth switch SW4 is turned on so that the charging voltage Vs/3 to the second capacitor Cr2 is supplied to the second multiplying unit 111.

The second diode D2 is connected between a common terminal of the fourth switch SW4 and a ground level voltage source (not illustrated) and the second capacitor Cr2, thereby preventing an inverse current. The third diode D3 is connected between the fourth switch SW4 and the second multiplying unit 111, thereby preventing an inverse current.

The second multiplying unit 111 is connected between the first voltage source 110 and the sustain pulse supply controller 113. The second multiplying unit 111 is charged to a sum of the voltage Vs/3 of the furst voltage source 110 and the charging voltage Vs/3 to the first multiplying unit 112, and then supplies the multiplying voltage Vs equal to three times the voltage Vs/3 of the first voltage source 110 to the panel capacitor Cp.

The multiplying voltage is equal to the sustain voltage Vs finally supplied to the panel capacitor Cp.

The first capacitor Cr1 is connected between a common terminal of the fifth switch SW5 and the third diode D3 and a common tenninal of a first switch SW1 and a first diode D1. The first capacitor Cr1 is charged to a sum of the voltage Vs/3 of the first voltage source 110 and the charging voltage to the first multiplying unit 112, and then supplies the multiplying voltage Vs to the panel capacitor Cp.

The third switch SW3 is connected between a common terminal ofthe first voltage source 110 and the first diode D1 and a common terminal ofthe fifth switch SW5 and the third diode D3. The third switch SW3 is turned on so that a voltage of the first capacitor Cr1 rises to the multiplying voltage Vs being the sustain voltage to be supplied to the panel capacitor Cp while charging the second capacitor Cr2 to the voltage Vs/3 ofthe first voltage source 110.

The first diode D1 is connected between a common terminal ofthe first capacitor Cr1 and the first switch SW1 and the first voltage source 110, thereby preventing an inverse current.

The sustain pulse supply controller 113 is connected between the second multiplying unit 111 and the panel capacitor Cp. The sustain pulse supply controller 113 controls the supplying of the multiplying voltage Vs supplied by the second multiplying unit 111 to the panel capacitor Cp.

The first switch SW1 is connected between a common terminal of the first diode D1 and the first capacitor Cr1 and the panel capacitor Cp. The first switch SW1 is turned on so that the multiplying voltage Vs is supplied to the panel capacitor Cp.

A second switch SW2 is connected between the panel capacitor Cp and the ground level voltage source. The second switch SW2 is turned on so that a ground level voltage GND is supplied to the panel capacitor Cp.

The first to fifth switches SW1 to SW5 control the flowing of a current through their turn-on and turn-off operations. The first to fifth switches SW1 to SW5 function as a semiconductor switch element such as MOSFET, IGBT, SCR, BJT. Further, the first diode D1, the second diode D2 and the third diode D3 may be removed.

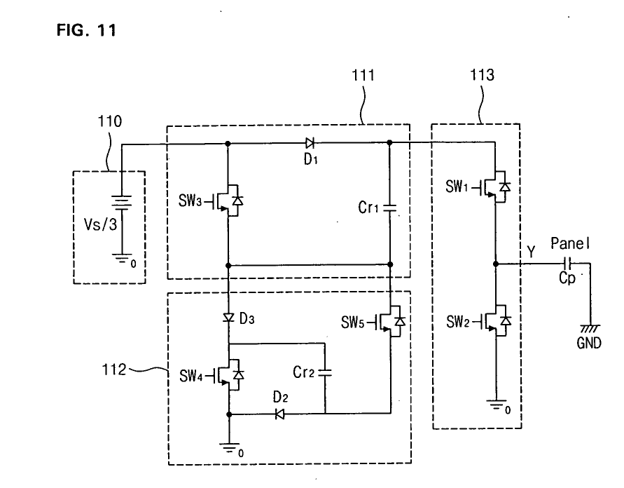

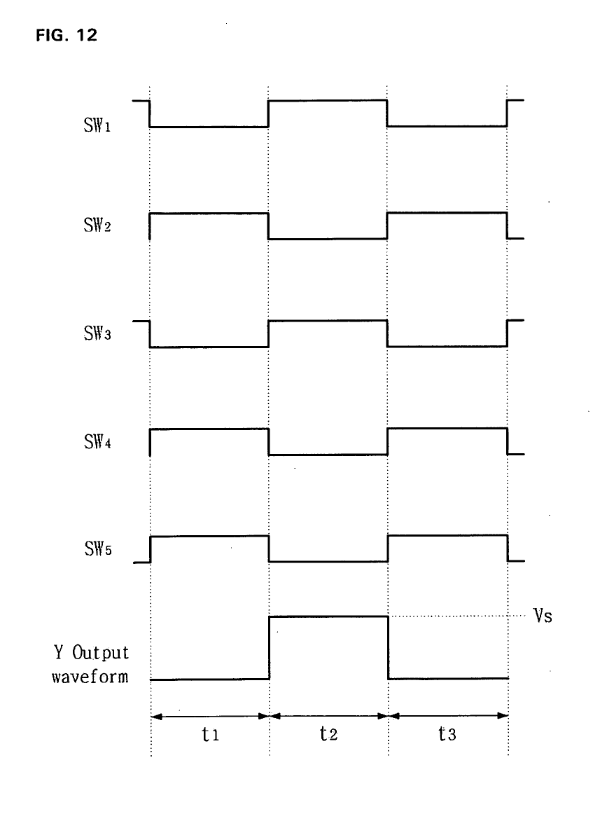

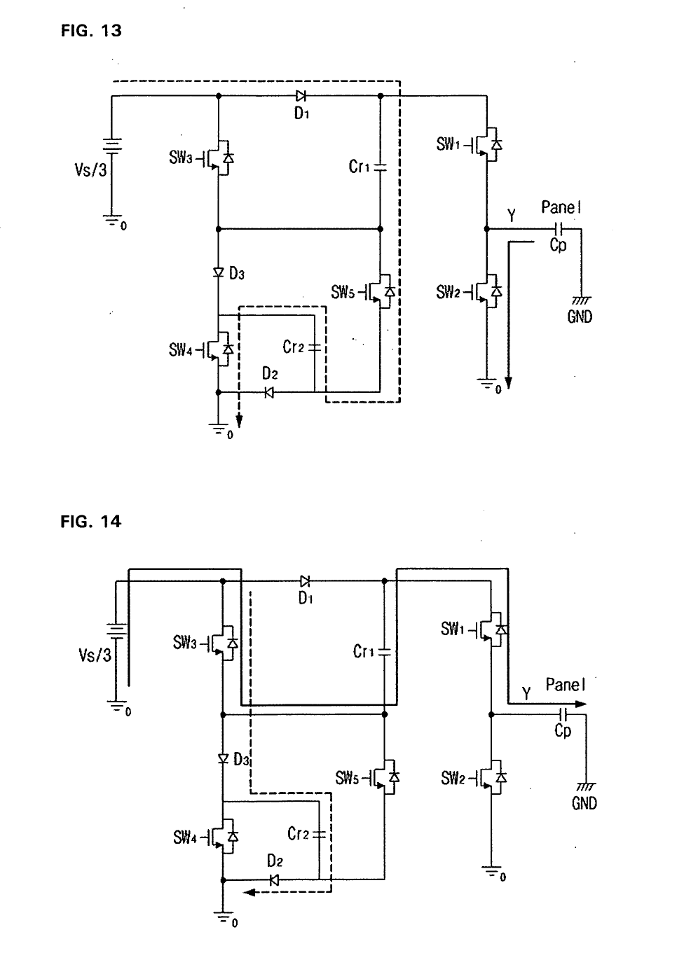

FIG. 12 is a timing chart illustrating on/off time of switches of FIG. 11. FIGS. 13 and 14 are a circuit diagram of a current path formed in accordance with the on/off timing of the switches illustrated in FIG. 12.

Referring to FIGS. 12 to 14, during a period t1, the second switch SW2, the fourth switch SW4 and the fifth switch SW5 are turned on in response to second, fourth and fifth switching control signals in a high state supplied by a timing controller (not illustrated).

As a result, as illustrated in FIG. 13, a current path (indicated by a bold solid line) passing through the panel capacitor Cp, the second switch SW2 and the ground level voltage source is formed such that a voltage of the panel capacitor Cp is maintained at the ground level voltage GND during the period t1. Further, a current path (indicated by a dotted line) passing through the first voltage source 110, the first diode D1, the first capacitor Cr1, the fifth switch SW5, the second capacitor Cr2, the fourth switch SW4 and the ground level voltage source is formed.

As aresult, during theperiod t1, the first capacitor Cr1 is charged to a sum (i.e., a voltage 2 Vs/3 equal to two-thirds of the sustain voltage Vs) of a charging voltage Vs/3 to the second capacitor Cr2 during a period t2, which will be described later, and the voltage Vs/3 to the first voltage source 110.

During the period t2, the first switch SW1 and the third switch SW3 are turned on in response to first and third switching control signals in a high state supplied by the timing controller. Further, the second switch SW2, the fourth switch SW4 and the fifth switch SW5 are turned off in response to second, fourth and fifth switching control signals in a low state.

As a result, as illustrated in FIG. 14, a current path (indicated by a bold solid line) passing through the first voltage source 110, the third switch SW3, the first capacitor Cr1, the first switch SW1 and the panel capacitor Cp is formed A sum (i.e., the multiplying voltage Vs) of a charging voltage 2Vs/3 to the first capacitor Cr1 during the period t1 and a voltage Vs/3 of the first capacitor Cr1 supplied by the first voltage source 11 through the current path formed during the period t2is supplied to the panel capacitor Cp. Accordingly, a voltage of the panel capacitor Cp is maintained at the sustain voltage Vs during the period t2.

Further, a current path (indicated by a dotted line) passing through the first voltage source 110, the third switch SW3, the third diode D3, the second capacitor Cr2, the second diode D2 and the ground level voltage source are formed.

As a result, the second capacitor Cr2 is charged to the voltage Vs/3 of the first voltage source 110 during the period t2.

As described above, a voltage of a sustain voltage source is not direcly supplied to the panel capacitor Cp, and a voltage Vs equal to three times the voltage Vs/3 of the first voltage source 110 is supplied to the panel capacitor Cp through the first capacitor Cr1 of the second multiplying unit 111. Accordingly, voltage stress applied to the components (for exanmple, the first and third switches SW1 and SW3) in the circuit of the plasma display apparatus is reduced to a voltage of Vs/3 equal to one third of the sustain voltage Vs, thereby using the switches with low capacitance.

Afterwards, a sustain pulse is supplied to the panel capacitor Cp by repeating the operations performed during the periods t1 and t2.

Referring to the driving waveform of the plasma display apparatus illustrated in FIG. 1, a magnitude of the sustain pulse SUSP supplied to the scan electrodes Y and the sustain electrodes Z during the sustain period SP is about three to four times a magnitude of the data pulse DP supplied to the address electrodes X during the address period AP.

Accordingly, the data pulse DP of the positive polarity may be supplied to the address electrodes X during the address period AP using the voltage Vs/3 of the first voltage source 110 in the plasma display apparatus according to the third embodiment.

This causes a reduction in the number of voltage sources, thereby reducing the manufacturing cost.

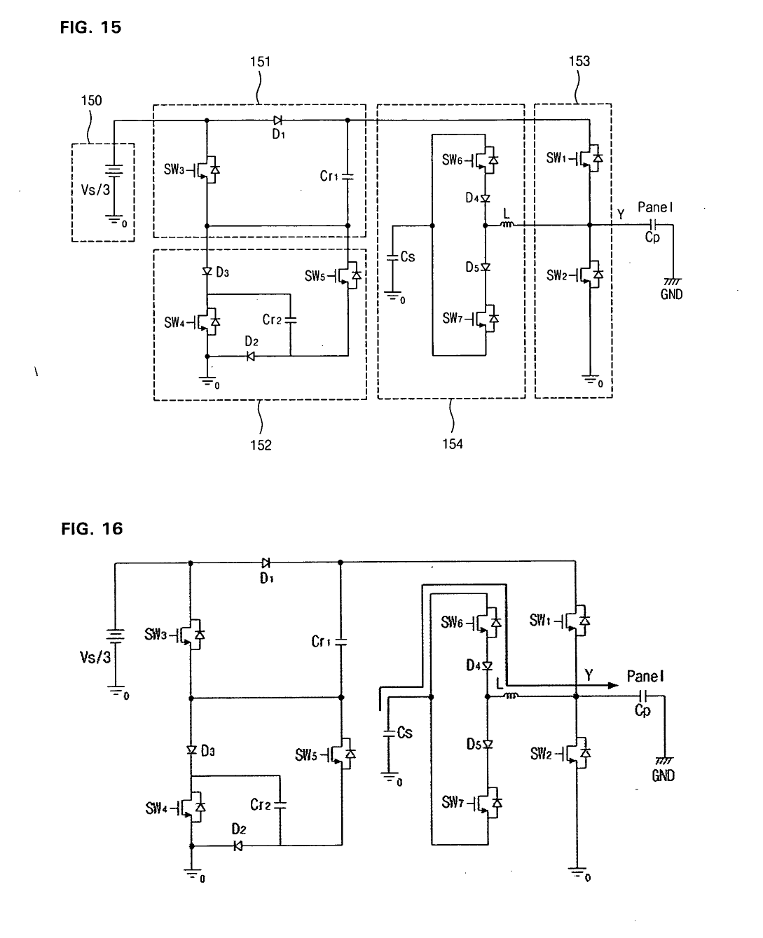

The following is a detailed description of a plasma display apparatus according to a fourth embodiment, with reference to FIGS. 15 to 19.

FIG. 15 is a circuit diagram of a plasma display apparatus according to a fourth embodiment.

As illustrated in FIG. 15, the plasma display apparatus according to the fourth embodiment comprises a first voltage source 150, a first multiplying unit 152, a second multiplying unit 151, a sustain pulse supply controller 153 and an energy recovery/supply unit 154.

Since the configuration of the plasma display apparatus according to the fourth embodiment is the same as the configuration of the plasma display apparatus according to the third embodiment except the energy recovery/supply unit 154, a description thereof is omnitted.

The energy recovery/supply unit 154 comprises a source capacitor Cs, an inductor L, a sixth switch SW6, a seventh switch SW7, a fourth diode D4 and a fifth diode D5. The energy recovery/supply unit 154 is connected to a common terminal of a panel capacitor Cp, a first switch SW1 and a second switch SW2. The energy recovery/supply unit 154 recovers energy from the panel capacitor Cp and supplies the recovered energy to the panel capacitor Cp.

The source capacitor Cs is connected to a conrnon terminal of the sixth switch SW6 and the seventh switch SW7. The source capacitor Cs recovers a charging voltage of the panel capacitor Cp when generating a sustain discharge, and is then charged to the charging voltage. The source capacitor Cs supplies the voltage charged inside the source capacitor Cs to the panel capacitor Cp.

The inductor L is connected between the source capacitor Cs and the sustain pulse supply controller 153, and has constant inductance. The inductor L and the panel capacitor Cp form a resonance circuit.

The sixth switch SW6 and the seventh switch SW7 are connected between the source capacitor Cs and the inductor L in paralleL The sixth switch SW6 is turned on when the source capacitor Cs recovers the charging voltage to the panel capacitor Cp, and the seventh switch SW7 is turned on when supplying again the voltage charged inside the source capacitor Cs to the panel capacitor Cp.

The fourth diode D4 is connected between the sixth switch SW6 and the inductor L, thereby preventing an inverse current. The fifth diode D5 is connected between the seventh switch SW7 and the inductor L, thereby preventing an inverse current.

The first to seventh switches SW1 to SW7 control the flowing of a current through their turn-on and turn-off operations. The first to seventh switches SW1 to SW7 function as a semiconductor switch element such as MOSFET, IGBT, SCR, BJT. Further, a first diode D1, a second diode D2, a third diode D3, the fourth diode D4 and the fifth diode D5 may be removed.

FIGS. 16 to 19 are a circuit diagram of a current path formed in accordance with on/off timing of switches of the plasma display apparatus of FIG. 15.

Suppose that the charging voltage to the panel capacitor Cp is equal to 0V, and the charging voltage to the source capacitor Cs is equal to one half the sustain voltage Vs.

Referring to FIG. 16, the sixth switch SW6 is turned on in response to a sixth switching control signal in a high state supplied by a timing controller (not illustrated).

As a result, as illustrated in FIG. 16, a current path passing through the source capacitor Cs, the sixth switch SW6, the fourth diode D4, the inductor L and the panel capacitor Cp is formed such that the inductor L and the panel capacitor Cp form serial resonance. Accordingly, a voltage of the panel capacitor Cp rises from a ground level voltage GND to the sustain voltage Vs.

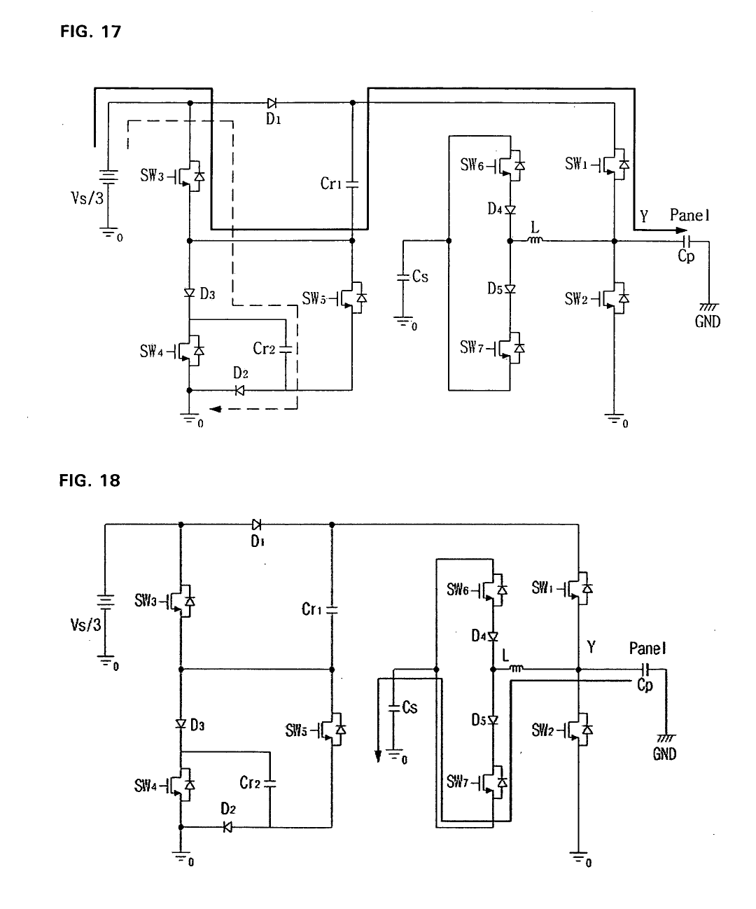

Referring to FIG. 17, the first switch SW1 and the third switch SW3 are turned on in response to first and third switching control signals in a high state supplied by the timing controller.

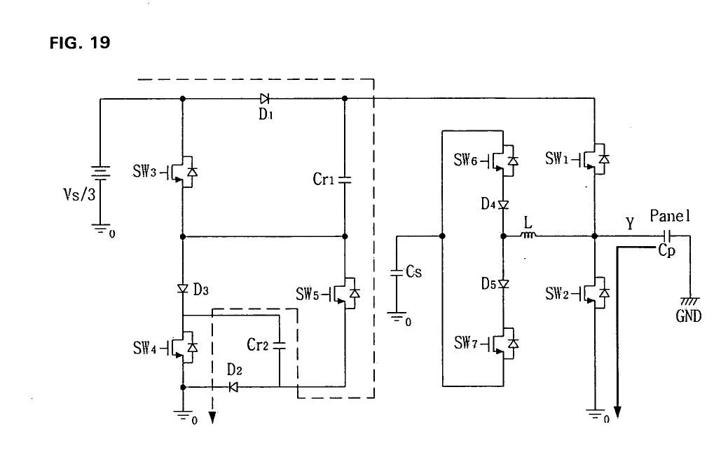

As a result, as illustrated in FIG. 17, a current path (indicated by a bold solid line) passing through the first voltage source 150, the third switch SW3, a first capacitor Cr1, the first switch SW1 and the panel capacitor Cp is formed A sum (i.e., a multiplying voltage Vs) of a charging voltage 2Vs/3 to the first capacitor Cr1 during an operation of a circuit illustrated in FIG. 19, which will be described later, and a voltage Vs/3 of the first capacitor Cr1 supplied by the first voltage source 150 through the current path illustrated in FIG. 17 is supplied to the panel capacitor Cp.

Accordingly, a voltage of the panel capacitor Cp is maintained at the sustain voltage Vs during the operation of the circuit illustrated in FIG. 17.

Further, a current path (indicated by a dotted line) passing through the first voltage source 150, the third switch SW3, the third diode D3, a second capacitor Cr2, the second diode D2 and a ground level voltage source (not illustrated) is formed Accordingly, the second capacitor Cr2 is charged to a voltage Vs/3 of the first voltage source 150 during the operation of the current path illustrated in FIG. 17.

As described above, a voltage of a sustain voltage source is not directly supplied to the panel capacitor Cp, and a voltage Vs equal to three times the voltage Vs/3 of the first voltage source 150 is supplied to the panel capacitor Cp through the first capacitor Cr1 of the second multiplying unit 151. Accordingly, voltage stress applied to the components (for example, the first and third switches SW1 and SW3) in the circuit of the plasma display apparatus is reduced to a voltage of Vs/3 equal to one third of the sustain voltage Vs, thereby using the switches with low capacitance.

Referring to FIG. 18, the seventh switch SW7 is turned on in response to a seventh switching control signal in a high state supplied by the tiring controller. As a result, as illustrated in FIG. 18, a current path passing through the panel capacitor Cp, the inductor L, the fifth diode D5, the seventh switch SW7 and the source capacitor Cs is formed such that the inductor L and the panel capacitor Cp form serial resonance. Accordingly, a voltage of the panel capacitor Cp falls from the sustain voltage Vs to the ground level voltage GND.

Referring to FIG. 19, the second switch SW2, the fourth switch SW4 and the fifth switch SW5 are turned on in response to second, fourth and fifth switching control signals in a high state supplied by the timing controller.

As a result, as illustrated in FIG. 19, a current path (indicated by a bold solid line) passing through the panel capacitor Cp, the second switch SW2 and the ground level voltage source is formed such that a voltage of the panel capacitor Cp is maintained at the ground level voltage GND during the operation of the circuit illustrated in FIG. 19.

Further, a current path (indicatedby a dotted line) passing through the first voltage source 150, the first diode D1, the first capacitor Cr1, the fifth switch SW5, the second capacitor Cr2, the fourth switch SW4 and the ground level voltage source is formed.

As a result, during the operation of the circuit illustrated in FIG. 19, the first capacitor Cr1 is charged to a sum (i.e, a voltage 2Vs/3 equal to two-tirds of the sustain voltage Vs) of a charging voltage Vs/3 to the second capacitor Cr2 during the operation of the circuit illustrated in FIG. 17 and the voltage Vs/3 ofthe first voltage source 150.

Afterwards, a sustain pulse is supplied to the panel capacitor Cp by repeating the operations illustrated in FIGS. 16 to 19.

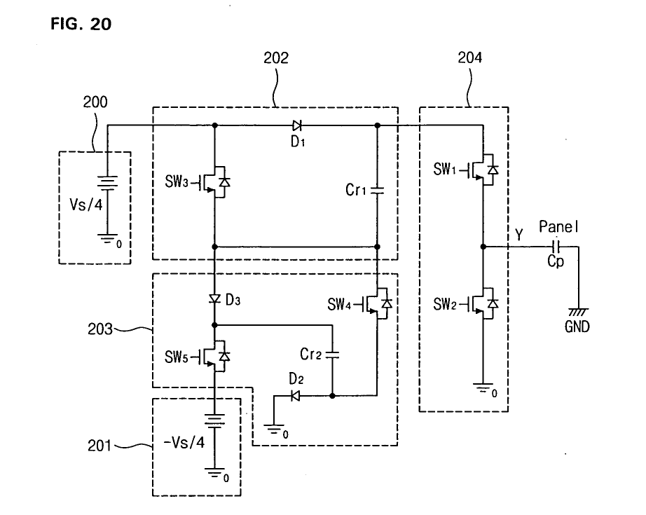

FIG. 20 is a circuit diagram of a plasma display apparatus according to a fifth embodiment.

As illustrated in FIG. 20, the plasma display apparatus according to the fifth embodiment comprises a first voltage source 200, a second voltage source 201, a first multiplying unit 203, a second multiplying unit 202 and a sustain pulse supply controller 204.

The first voltage source 200 is connected to one tenninal of the second multiplying unit 202 such that a first capacitor Cr1 of the second multiplying unit 202 is charged to a voltage of the first voltage source 200, and a second capacitor Cr2 of the first multiplying unit 203 is charged to a voltage of the first voltage source 200. The second multiplying unit 202 raises a charging voltage to the first capacitor Cr1 to a multiplying voltage Vs so that a voltage finally supplied to a panel capacitor Cp is equal to a sustain voltage Vs.

The voltage of the first voltage source 200 may be equal to one-fourth of the multiplying voltage Vs to be finally supplied to the panel capacitor Cp.

The panel capacitor Cp equivalently indicates capacitance formed between a scan electrode Y and a sustain electrode Z of the plasma display panel.

The circuit having the configuration illustrated in FIG. 20 is symmetrically installed in each of the scan electrode Y and the sustain electrode Z with the panel capacitor Cp being interposed between the scan electrode Y and the sustain electrode Z. In FIG. 20, the circuit installed in the scanelectrode Y is illustrated.

The second voltage source 201 is connected to one terminal of the first multiplying unit 203 such that the second capacitor Cr2 of the first multiplying unit 203 is charged to a voltage of the second voltage source 201.

The first multiplying unit 203 is charged to a sum of the voltage Vs/4 of the first voltage source 200 and the voltage −¼Vs of the second voltage source 201, and then supplies the charging voltage Vs/2 to the second multiplying unit 202.

The second capacitor Cr2 is connected between a common terminal of a third diode D3 and a fifth switch SW5 and a common terminal of a second diode D2 and a fourth switch SW4. The second capacitor Cr2 is charged to a sum of the voltage Vs/4 of the first voltage source 200 and the voltage −Vs/4 of the second voltage source 201, and then supplies the charging voltage Vs/2 to the second multiplying unit 202.

The fourth switch SW4 is connected between a common terminal of the first capacitor Cr1 and a third switch SW3 and a common terminal of the second capacitor Cr2 and the second diode D2. The fourth switch SW4 is turned on so that the charging voltage Vs/2 to the second capacitor Cr2 is supplied to the second multiplying unit 201.

The fifth switch SW5 is connected between a common terminal of the second capacitor Cr2 and the third diode D3 and the second voltage source 201 in parallel to the second capacitor Cr2. The fifth switch SW5 is turned on so that the second capacitor Cr2 is charged to a sum (i.e., a voltage Vs/2) of the voltage Vs/4 of the first voltage source 200 and the voltage −Vs/4 of the second voltage source 201.

The second diode D2 is connectedbetweena common terminal of the fourth switch SW4 and the second capacitor Cr2 and a ground level voltage source (not illustrated), thereby preventing an inverse current. The third diode D3 is connected between the fifth switch SW5 and the second multiplying unit 202, thereby preventing an inverse current.

The second multiplying unit 202 is connected between the first voltage source 200 and the sustain pulse supply controller 204. The second multiplying unit 202 is charged to a sum of the voltage Vs/4 of the first voltage source 200 and the charging voltage Vs/2 to the first multiplying unit 203, and then supplies the multiplying voltage Vs equal to four times the voltage of the first voltage source 200 to the panel capacitor Cp.

The multiplying voltage is equal to the sustain voltage Vs finally supplied to the panel capacitor Cp.

The first capacitor Cr1 is connected between a common terminal of the fourth switch SW4 and the third diode D3 and a common terminal of a first switch SW1 and a first diode D1. The first capacitor Cr1 is charged to a sum of the voltage Vs/4 of the first voltage source 200 and the charging voltage to the first multiplying unit 203, and then supplies the multiplying voltage Vs to the panel capacitor Cp.

The third switch SW3 is connected between a common terminal of the first voltage source 200 and the first diode D1 and a common terminal of the fourth switch SW4 and the third diode D3. The third switch SW3 is turned on so that a voltage of the first capacitor Cr1 rises to the multiplying voltage Vs being the sustain voltage to be supplied to the panel capacitor Cp while charging the second capacitor Cr2 to the voltage Vs/4 of the first voltage source 200.

The first diode D1 is connected between a common terminal of the first capacitor Cr1 and the first switch SW1 and the first voltage source 200, thereby preventing an inverse current.

The sustain pulse supply controller 204 is connected between the second multiplying unit 202 and the panel capacitor Cp. The sustain pulse supply controller 204 controls the supplying of the multiplying voltage Vs supplied by the second multiplying unit 202 to the panel capacitor Cp.

The first switch SW1 is connected between a common terminal of the first diode D1 and the first capacitor Cr1 and the panel capacitor Cp. The first switch SW1 is turned on so that the multiplying voltage Vs is supplied to the panel capacitor Cp.

A second switch SW2 is connected between the panel capacitor Cp and the ground level voltage source. The second switch SW2 is turned on so that a ground level voltage GND is supplied to the panel capacitor Cp.

The first to fifth switches SW1 to SW5 control the flowing of a current through their turn-on and turn-off operations. The first to fifth switches SW1 to SW5 function as a semiconductor switch element such as MOSFET, IGBT, SCR, BJT. Further, the first diode D1, the second diode D2 and the third diode D3 may be removed.

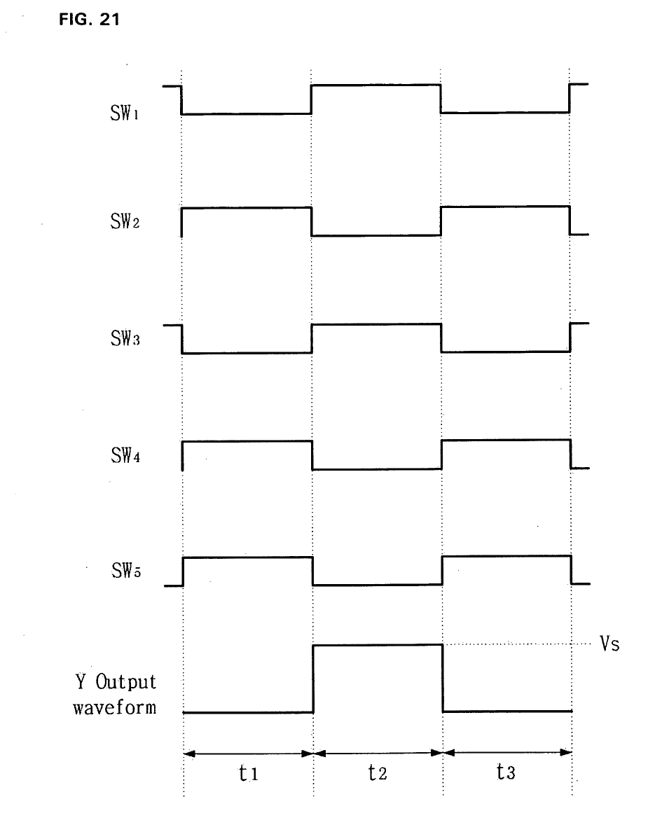

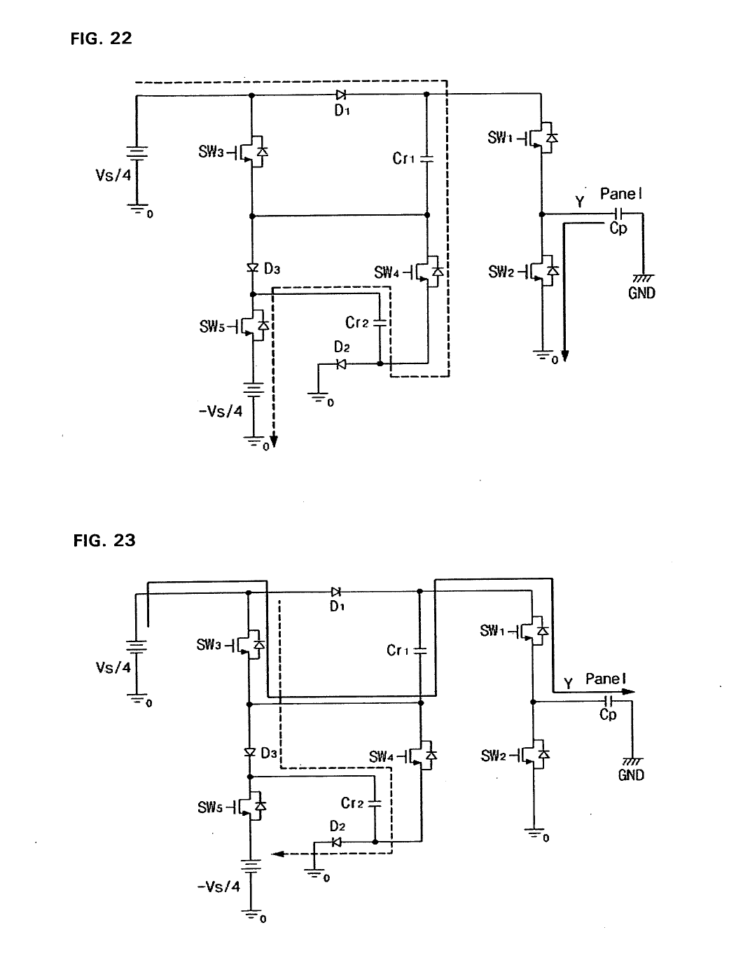

FIG. 21 is a timing chart illustrating on/off time of switches of FIG. 20. FIGS. 22 and 23 are a circuit diagram of a current path formed in accordance with the on/off timing of the switches illustrated in FIG. 21.

Referring to FIGS. 21 to 23, during a period t1, the secand switch SW2, the fourth switch SW4 and the fifth switch SW5 are turned on in response to second, fourth and fifth switching control signals in a high state supplied by a timing controller (not illustrated).

As a result, as illustrated in FIG. 22, a current path (indicated by a bold solid line) passing through the panel capacitor Cp, the second switch SW2 and the ground level voltage source is formed such that a voltage of the panel capacitor Cp is maintained at the ground level voltage GND during the period t1.

Further a current path (indicated by a dotted line) passing through the first voltage source 200, the first diode D1, the first capacitor Cr1, the fourth switch SW4, the second capacitor Cr2, the fifth switch SW5 and the ground level voltage source is formed.

As a result, during the period t1, the second capacitor Cr2 is charged to the voltage −Vs/4of the second voltage source 201, and a sum (i.e., a voltage Vs/2 equal to one half the sustain voltage Vs) of the charging voltage Vs/4 to the second capacitor Cr2 during a period t2, which will be described later, and the charging voltage −Vs/4 to the second voltage source 201 is supplied to the first capacitor Cr1. Accordingly, the first capacitor Cr1 is charged to a voltage 3 Vs/4 equal to three-fourths of the sustain voltage Vs.

During the period t2, the first switch SW1 and the third switch SW3 are turned on in response to first and third switching control signals in a high state supplied by the timing controller. Further, the second switch SW2, the fourth switch SW4 and the fifth switch SW5 are turned off in response to second, fourth and fifth switching control signals in a low state.

As a result, as illustrated in FIG. 23, a current path (indicated by a bold solid line) passing through the first voltage source 200, the third switch SW3, the first capacitor Cr1, the first switch SW1 and the panel capacitor Cp is formed A sum (i.e., the multiplying voltage Vs) of a charging voltage 3 Vs/4 to the first capacitor Cr1 during the period t1 and the voltage Vs/4 of the first capacitor Cr1 supplied by the first voltage source 200 through the current path formed during the period t2is supplied to the panel capacitor Cp.

Accordingly, a voltage of the panel capacitor Cp is maintained at the sustain voltage Vs during the period t2.

Further, a current palh (indicated by a dotted line) passing through the first voltage source 200, the third switch SW3, the third diode D3, the second capacitor Cr2, the second diode D2 and the ground level voltage source are formed As a result, the second capacitor Cr2 is charged to the voltage Vs/4 ofthe first voltage source 200 during the period t2.

As described above, a voltage of a sustain voltage source is not directly supplied to the panel capacitor Cp, and a voltage Vs equal to four times the voltage Vs/4 of the first voltage source 200 is supplied to the panel capacitor Cp through the first capacitor Cr1 of the second multiplying unit 202. Accordingly, voltage stress applied to the components (for example, the first and third switches SW1 and SW3) in the circuit of the plasma display apparatus is reduced to a voltage of Vs/4 equal to one-fourth of the sustain voltage Vs, thereby using the switches with low capacitance.

Afterwards, a sustain pulse is supplied to the panel capacitor Cp by repeating the operations performed during the periods t1 and t2.

Referring to the driving waveform of the plasma display apparatus illustrated in FIG. 1, a magnitude of the sustain pulse SUSP supplied to the scan electrodes Y and the sustain electrodes Z during the sustain period SP is about three times to about four times larger than a magnitude of the data pulse DP supplied to the address electrodes X during the address period AP.

Further, a magnitude of the sustain pulse SUSP supplied to the scan electrodes Y and the sustain electrodes Z during the sustain period SP is about three times to about four times larger than a magnitude of the scan pulse SCNP of the negative polarity supplied to the scan electrodes Y during the address period AP.

Acccrdingly, in the plasma display apparatus according to the fifth embodiment the data pulse DP of the positive polarity may be supplied to the address electrodes X during the address period AP using the voltage Vs/4 of the first voltage source 200, and the scan pulse SCNP of the negative polarity may be supplied to the scan electrodes Y during the address period AP using the voltage −Vs/4 of the second voltage source 201.

This causes a reduction in the number of voltage sources, thereby reducing the manufacturing cost.

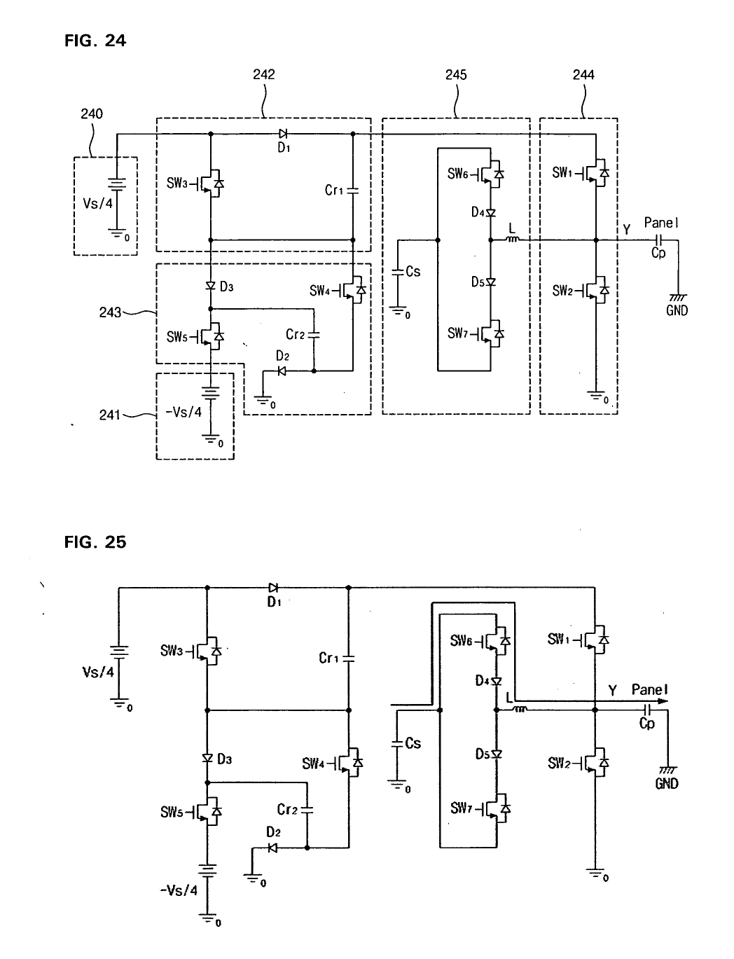

The following is a detailed description of a plasma display apparatus according to a sixth embodiment, with reference to FIGS. 24 to 28.

FIG. 24 is a circuit diagram of a plasma display apparatus according to a sixth embodiment.

As illustrated in FIG. 24, the plasma display apparatus according to the sixth embodiment comprises a first voltage source 240, a second voltage source 241, a first multiplying unit 243, a second multiplying unit 242, a sustain pulse supply controller 244 and an energy recovery/supply unit 245.

Since the configuration of the plasma display apparatus according to the sixth embodiment is the same as the configuration of the plasma display apparatus acceding to the fifth embodiment except the energy recovery/supply unit 245, a description thereof is omitted.

The energy recovery/supply unit 245 comprises a source capacitor Cs, an inductor L, a sixth switch SW6, a seventh switch SW7, a fourth diode D4 and a fifth diode D5. The energy recovery/supply unit 245 is connected to a common terminal of a panel capacitor Cp, a first switch SW1 and a second switch SW2. The energy recovery/supply unit 245 recovers energy from the panel capacitor Cp and supplies the recovered energy to the panel capacitor Cp.

The source capacitor Cs is connected to a common terminal of the sixth switch SW6 and the seventh switch SW7. The source capacitor Cs recovers a charging voltage to the panel capacitor Cp when generating a sustain discharge, and is then charged to the charging voltage. The source capacitor Cs supplies the voltage charged inside the source capacitor Cs to the panel capacitor Cp.

The inductor L is connected between the source capacitor Cs and the sustain pulse supply controller 244, and has constant inductance. The inductor L and the panel capacitor Cp form a resonance circuit.

The sixth switch SW6 and the seventh switch SW7 are connected between the source capacitor Cs and the inductor L in paralleL The sixth switch SW6 is turned on when the source capacitor Cs recovers the charging voltage to the panel capacitor Cp, and the seventh switch SW7 is turned on when supplying again the voltage charged inside the source capacitor Cs to the panel capacitor Cp.

The fourth diode D4 is connected betweenthe sixth switch SW6 and the inductor L, and the fifth diode D5 is connected between the seventh switch SW7 and the inductor L, thereby preventing an inverse current.

The first to seventh switches SW1 to SW7 control the flowing of a current through their turn-on and turn-off operations. The first to seventh switches SW1 to SW7 function as a semiconductor switch element such as MOSFET, IGBT, SCR, BJT. Further, a first diode D1, a second diode D2, a third diode D3, the fourth diode D4 and the fifth diode D5 may be removed.

FIGS. 25 to 28 are a circuit diagram of a current path forrned in accordance with on/off timing of switches of the plasma display apparatus of FIG. 24.

Suppose that the charging voltage to the panel capacitor Cp is equal to 0 V, and the charging voltage to the source capacitor Cs is equal to one half the sustain voltage Vs.

Referring to FIG. 25, the sixth switch SW6 is turned on in response to a sixth switching control signal in a high state supplied by a timing controller (not illustrated).

As a result, as illustrated in FIG. 25, a current path passing through the source capacitor Cs, the sixth switch SW6, the fourth diode D4, the inductor L and the panel capacitor Cp is formed such that the inductor L and the panel capacitor Cp form serial resonance. Accordingly, a voltage of the panel capacitor Cp rises from a ground level voltage GND to the sustain voltage Vs.

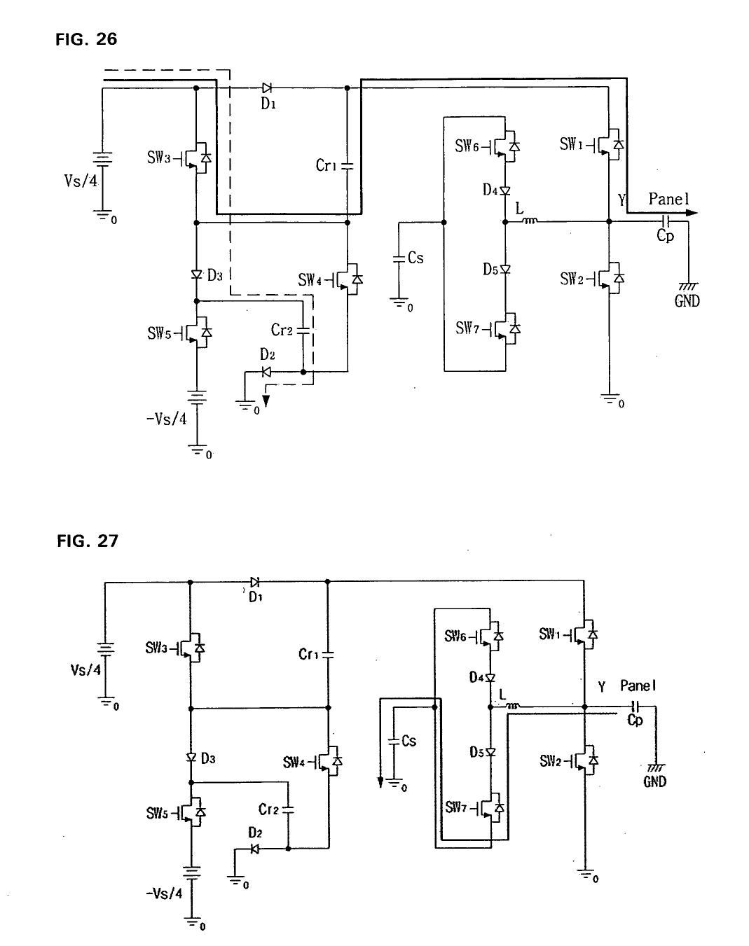

Referring to FIG. 26, the first switch SW1 and the third switch SW3 are turned on in response to first and third switching control signals in a high state supplied by the timing controller.

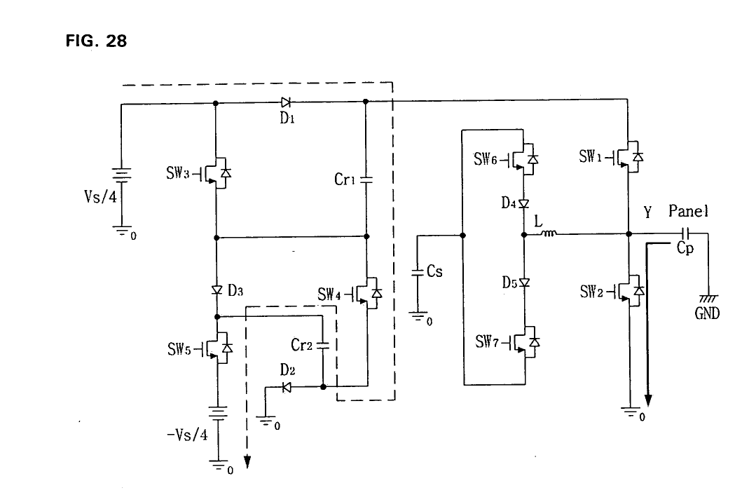

As a result, as illustrated in FIG. 26, a current path (indicated by a bold solid line) passing through the first voltage source 240, the third switch SW3, a first capacitor Cr1, the first switch SW1 and the panel capacitor Cp is formed A sum (i.e., a multiplying voltage Vs) of a charging voltage 3 Vs/4 to the first capacitor Cr1 during an operation of a circuit illustrated in FIG. 28, which will be described later, and a voltage Vs/4 of the first capacitor Cr1 supplied by the first voltage source 240 through the current path illustrated in FIG. 26 is supplied to the panel capacitor Cp.

Accordingly, a voltage of the panel capacitor Cp is maintained at the sustain voltage Vs during the operation of the circuit illustrated in FIG. 26.

Further, a current path passing (indicated by a dotted line) through the first voltage source 240, the third switch SW3, the third diode D3, a second capacitor Cr2, the second diode D2 and a ground level voltage source (not illustrated) is formed Accordingly, the second capacitor Cr2 is charged to a voltage Vs/4 of the first voltage source 240 during the operation of the current path illustrated in FIG. 26.

As described above, a voltage of a sustain voltage source is not directly supplied to the panel capacitor Cp, and a voltage Vs equal to four times the voltage Vs/4 of the first voltage source 240 is supplied to the panel capacitor Cp through the first capacitor Cr1 of the second multiplying unit 242. Accordingly, voltage stress applied to the components (for example, the first and third switches SW1 and SW3) in the circuit of the plasma display apparatus is reduced to a voltage of Vs/4 equal to one-fourth of the sustain voltage Vs, thereby using the switches with low capacitance.

Referring to FIG. 27, the seventh switch SW7 is turned on in response to a seventh switching control signal in a high state supplied by the timing controller.

As a result, as illustrated in FIG. 27, a current path passing through the panel capacitor Cp, the inductor L, the fifth diode D5, the seventh switch SW7 and the source capacitor Cs is formed such that the inductor L and the panel capacitor Cp form serial resonance. Accordingly, a voltage of the panel capacitor Cp falls from the sustain voltage Vs to the ground level voltage GND.

Referring to FIG. 28, the second switch SW2, the fourth switch SW4 and the fifth switch SW5 are turned on in response to second, fourth and fifth switching control signals in a high state supplied by the timing controller.

As a result, as illustrated in FIG. 28, a current path (indicated by a bold solid line) passing through the panel capacitor Cp, the second switch SW2 and the ground level voltage source is formed such that a voltage of the panel capacitor Cp is maintained at the ground level voltage GND during the operation of the circuit illustrated in FIG. 28.

Further, a current path (indicated by a dotted line) passing through the first voltage source 240, the first diode D1, the first capacitor Cr1, the fourth switch SW4, the second capacitor Cr2, the fifth switch SW5 and the ground level voltage source is formed.

As a result, the second capacitor Cr2 is charged to a sum (i.e., a voltage Vs/2) of the charging voltage Vs/4 to the second capacitor Cr2 during the operation of the circuit illustrated in FIG. 26 and the voltage −Vs/4 of the second voltage source during the operation of the circuit illustrated in FIG. 28, and then the voltage Vs/2 is supplied to the first capacitor Cr1. Accordingly, the first capacitor Cr1 is charged to a voltage 3 Vs/4.

Afterwards, a sustain pulse is supplied to the panel capacitor Cp by repeating the operations illustrated in FIGS. 25 to 28.

As described above, the plasma display apparatus comprises the circuit having the low capacitance components, thereby reducing the manufacturing cost.

The foregoing embodiments and advantages are merely exemplary and are not to be construed as limiting the present invention. The present teacling can be readily applied to other types of apparatuses. The description of the foregoing embodiments is intended to be illustrative, and not to limit the scope of the claims. Many altematives, modifications, and variations will be apparent to those skilled in the art. In the claims, means-plus-function clauses are intended to cover the structures described herein as performing the recited finction and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a first voltage source;
a multiplying unit which is charged to a voltage of the first voltage source, and then supplies a multiplying voltage equal to two times the voltage of the first voltage source to a panel capacitor, and
a sustain pulse supply controller, connectd between the multiplying unit and the panel capacitor, for controlling the supplying of the multiplying voltage supplied by the multiplying unit to the panel capacitor.

2. The plasma display apparatus of claim 1, wherein a magnitude of the multiplying voltage is equal to a sustain voltage.

3. The plasma display apparatus of claim 2, wherein a magnitude of the voltage of the first voltage source is equal to one half the sustain voltage.

4. The plasma display apparatus of claim 2, wherein the multiplying unit comprises
a multiplying capacitor charged to the voltage of the first voltage source, for supplying the multiplying voltage to the panel capacitor, and
a third switch turned on to raise a voltage of the multiplying capacitor to the multiplying voltage.

5. The plasma display apparatus of claim 4, wherein the sustain pulse supply controller comprises
a first switch which is connected between the multiplying unit and the panel capacitor, and is turned on to supply the multiplying voltage to the panel capacitor, and
a second switch which is connected between the panel capacitor and a ground level voltage source, and is turned on to supply a ground level voltage to the panel capacitor and to charge the multiplying capacitor of the multiplying unit to the voltage of the first voltage source.

6. The plasma display apparatus of claim 5, wherein a current path for charging the multiplying capacitor to the voltage of the first voltage source is formed to pass through the first voltage source, the multiplying capacitor and the second switch.

7. The plasma display apparatus of claim 5, wherein a current path for supplying the sustain voltage to the panel capacitor is formed to pass through the first voltage source, the third switch, the multiplying capacitor and the first switch.

8. The plasma display apparatus of claim 1, further comprising an energy recovery/supply unit for recovering energy from the panel capacitor and for supplying the recovered energy to the panel capacitor.

9. A plasma display apparatus comprising:
a first voltage source;
a first multiplying unit charged to a voltage of the first voltage source;
a second multiplying unit which is charged to a sum of the voltage of the first voltage source and a charging voltage to the first multiplying unit, and then supplies a multiplying voltage equal to three times the voltage of the first voltage source to a panel capacitor, and
a sustain pulse supply controller, connected between the second multiplying unit and the panel capacitor, for controlling the supplying of the multiplying voltage supplied by the second multiplying unit to the panel capacitor.

10. The plasma display apparatus of claim 9, wherein a magnitude of the multiplying voltage is equal to a sustain voltage.

11. The plasma display apparatus of claim 10, wherein a magnitude of the voltage of the first voltage source is equal to one-third of the sustain voltage.

12. The plasma display apparatus of claim 10, wherein the first multiplying unit comprises
a second capacitor, charged to the voltage of the first voltage source, for supplying the charging voltage to the second multiplying unit,
a fifth switch turned on to supply the charging voltage to the second multiplying unit, and
a fourth switch connected in parallel to the second capacitor.

13. The plasma display apparatus of claim 12, wherein the second multiplying unit comprises
a first capacitor which is charged to the voltage of the first voltage source and a charging voltage to the first multiplying unit, and supplies the multiplying voltage to the panel capacitor, and
a third switch which is turned on to raise the voltage of the first capacitor to the multiplying voltage while charging the second capacitor to the voltage of the first voltage source.

14. The plasma display apparatus of claim 13, wherein the sustain pulse supply controller comprises
a first switch which is connected b etweenthe second multiplying unit and the panel capacitor, and is turned on to supply the multiplying voltage to the panel capacitor, and
a second switch which is connectd between the panel capacitor and a ground level voltage source, and is turned on to supply a ground level voltage to the panel capacitor.

15. The plasma display apparatus of claim 14, wherein a current path for charging the second capacitor to the voltage of the first voltage source is formed to pass through the first voltage source, the third switch, the second capacitor and the ground level voltage source, and
a current path for charging the first capacitor to the voltage of the first voltage source and a charging voltage to the second capacitor is formed to pass through the first voltage source, the first capacitor, the fifth switch, the second capacitor, the fourth switch and the ground level voltage source.

16. The plasma display apparatus of claim 14, wherein a current path for supplying the sustain voltage to the panel capacitor is formed to pass through the first voltage source, the third switch, the first capacitor and the first switch.

17. The plasma display apparatus of claim 9, further comprising an energy recovery/supply unit for recovering energy from the panel capacitor and for supplying the recovered energy to the panel capacitor.

18. The plasma display apparatus of claim 11, wherein a data pulse is supplied to an address electrode using the first voltage source during an address period.

19. A plasma display apparatus comprising:
a first voltage source and a second voltage source;
a first multiplying unit charged to a voltage of the first voltage source and a voltage of the second voltage source;
a second multiplying unit which is charged to the voltage of the first voltage source and a charging voltage to the first multiplying unit, and then supplies a multiplying voltage equal to four times the voltage of the first voltage source to a panel capacitor, and
a sustain pulse supply controller, connected between the second multiplying unit and the panel capacitor, for controlling the supplying of the multiplying voltage supplied by the second multiplying unit to the panel capacitor.

20. The plasma display apparatus of claim 19, wherein a magnitude of the multiplying voltage is equal to a sustain voltage.

21. The plasma display apparatus of claim 20, wherein a magnitude of the voltage of the first voltage source is equal to one quarter of the sustain voltage, and
a magnitude of the voltage of the second voltage source is equal to one quarter of the sustain voltage.

22. The plasma display apparatus of claim 20, wherein the first multiplying unit comprises
a second capacitor which is charged to the voltage of the first voltage source and the voltage of the second voltage source, and supplies the charging voltage to the second multiplying unit,
a fourth switch which is turned on to supply the charging voltage to the first multiplying unit to the second multiplying unit, and
a fifth switch connected in parallel to the second capacitor.

23. The plasma display apparatus of claim 22, wherein the second multiplying unit comprises
a first capacitor which is which is charged to the voltage of the first voltage source and a charging voltage to the first multiplying unit, and supplies the multiplying voltage to the panel capacitor, and
a third switch which is turned on to raise the voltage of the first capacitor to the multiplying voltage while charging the second capacitor to the voltage of the first voltage source.

24. The plasma display apparatus of claim 23, wherein the sustain pulse supply controller comprises
a first switch which is connectdb etween the second multiplying unit and the panel capacitor, and is turned on to supply the multiplying voltage to the panel capacitor, and
a second switch which is comneced betweenthe panel capacitor and a ground level voltage source, and is turned on to supply a ground level voltage to the panel capacitor.

25. The plasma display apparatus of claim 24, wherein a current path for charging the second capacitor to the voltage of the first voltage source is formed to pass through the first voltage source, the third switch, the second capacitor, and the ground level voltage source, and
a current path for charging the second capacitor to the voltage of the second voltage source and a current path for charging the first capacitor to the voltage of the first voltage source and the charging voltage to the second capacitor are formed to pass through the first voltage source, the first capacitor, the fourth switch, the second capacitor, the fifth switch and the second voltage source.

26. The plasna display apparatus of claim 24, wherein a current path for supplying the sustain voltage to the panel capacitor is formed to pass through the first voltage source, the third switch, the first capacitor and the first switch.

27. The plasma display apparatus of claim 19, fuither comprising an energy recovery/supply unit for recovering energy from the panel capacitor and for supplying the recovered energy to the panel capacitor.

28. The plasma display apparatus of claim 21, wherein a data pulse is supplied to an address electrode using the first voltage source during an address period.

29. The plasma display apparatus of claim 21, wherein a scan pulse of a negative polarity is supplied to a scan electrode using the second voltage source during an address period.
